(19) United States
(12) Patent Application Publication
(10) Pub. No.: US 2012/0156032 A1
(43) Pub. Date: Jun. 21, 2012

(54) DYNAMIC CROSS-SECTION FLUID ENERGY CAPTURE

(75) Inventors: Gary L. Durham, Stuart, FL (US); H. Stephen Durham, Port Saint Lucie, FL (US)

(73) Assignee: Just the 4 of US, LLC, Wichita, KS (US)

(21) Appl. No.: 12/921,791

(22) PCT Filed: Jul. 23, 2010
(86) PCT No.: PCT/US10/43000

§ 371 Date: Sep. 10, 2010

Related U.S. Application Data
(60) Provisional application No. 61/241,694, filed on Sep. 11, 2009.

(51) Int. Cl. F03D 3/06; F03D 7/06; F03D 5/00

(52) U.S. Cl. 416/1; 416/9

(57) ABSTRACT

A system comprises a main shaft configured to rotate about a main shaft axis, the main shaft comprising a hub. A first axle couples to the hub and rotates about a first axle axis in a first range of motion. A first wing couples to the first axle wherein the first range of motion orients the first wing within a range of attitudes bounded by and including a first attitude and a second attitude. The first attitude presents a first cross sectional surface area relative to a predetermined fluid flow direction and the second attitude presents a second cross sectional surface area relative to the predetermined fluid flow direction. The first cross sectional surface area is larger than the second cross sectional surface area. A second axle couples to the hub and rotates about a second axle axis in a second range of motion. The second axle axis is parallel to first axle axis and a second wing couples to the second axle. The second range of motion orients the second wing within a range of attitudes bounded by and including the first attitude and the second attitude and the first range of motion and the second range of motion orient the second wing at a first angle relative to the first wing.

### TECHNICAL FIELD

The present invention relates generally to the field of mechanical energy transformation and, in particular, to a method and system for dynamic cross-section fluid energy capture.

### BACKGROUND OF THE INVENTION

Modern vertical windmill design offers many important cost saving, efficiency, and maintenance features that horizontal windmill designs cannot provide as effectively. For example, some vertical windmill designs allow placement of the power generation unit on the ground instead of many meters in the air, which removes the cross-section of the power generation unit from the wind interaction area. As such, relocating the power generation unit encourages more efficient interaction of wing members with the wind, a wider wind speed tolerance for effective generation and, in some cases, lower overall height requirements for the same generating capacity. However, many common vertical windmill designs are unable to produce a wing design that interacts with the wind as efficiently as the propeller and wind-screw designs of horizontal windmills.

The most common attempted solution in vertical windmill wing designs has been to provide specially formed surfaces on the side of the wing intended to interact with the wind to create power on the shaft. These specially formed surfaces are usually intended to create high pressure behind the wing as it interacts with the wind rotating downwind. Typically, these specially formed surfaces are also intended to create low pressure in front of the wing as it interacts with the wind as it rotates upwind. Theoretically, in common systems, the differential between the pressure on the high-pressure surfaces traveling downwind and the low-pressure surfaces traveling upwind is supposed to result in a net gain of torque in one direction on the power shaft. Typically, however, common systems fail to achieve a significant net torque gain in practice.

For example, in typical systems, wing cross-sections shaped to create low pressure in front of the wing as it moves into the wind can only create this low pressure as an offset to its cross-sectional resistance to the wind as it rotates upwind, which creates a counter-torque on the wing, and thus the shaft. The upwind side design of the wing causes a low-pressure area in front of the wing that only partially offsets this cross-sectional counter-torque. Thus, the net torque of the wing traveling upwind is, though reduced, still a counter-torque on the windmill.

Therefore, there is a need for a system and/or method that addresses at least some of the problems and disadvantages associated with conventional systems and methods.

### BRIEF SUMMARY

The following summary is provided to facilitate an understanding of some of the innovative features unique to the embodiments disclosed and is not intended to be a full description. A full appreciation of the various aspects of the embodiments can be gained by taking into consideration the entire specification, claims, drawings, and abstract as a whole.

A system comprises a main shaft configured to rotate about a main shaft axis, the main shaft comprising a hub. A first axle couples to the hub and rotates about a first axle axis in a first range of motion. A first wing couples to the first axle wherein the first range of motion orients the first wing within a range of attitudes bounded by and including a first attitude and a second attitude. The first attitude presents a first cross sectional surface area relative to a predetermined fluid flow direction and the second attitude presents a second cross sectional surface area relative to the predetermined fluid flow direction. The first cross sectional surface area is larger than the second cross sectional surface area. A second axle couples to the hub and rotates about a second axle axis in a second range of motion. The second axle axis is parallel to first axle axis and a second wing couples to the second axle. The second range of motion orients the second wing within a range of attitudes bounded by and including the first attitude and the second attitude and the first range of motion and the second range of motion orient the second wing at a first angle relative to the first wing.

A method for capturing fluid energy comprises disposing a windmill within a fluid flow, the fluid flow comprising a flow direction. The windmill comprises a main shaft configured to rotate about a main shaft axis, the main shaft comprising a hub. A first axle couples to the hub and rotates about a first axle axis in a first range of motion. A first wing couples to the first axle. The first range of motion orients the first wing within a range of attitudes bounded by and including a first attitude and a second attitude. The first attitude presents a first cross sectional surface area relative to the flow direction and the second attitude presents a second cross sectional surface area relative to the flow direction. The first cross sectional surface area is larger than the second cross sectional surface area. A second axle couples to the hub and rotates about a second axle axis in a second range of motion. The second axle axis is parallel to first axle axis and a second wing couples to the second axle. The second range of motion orients the second wing within a range of attitudes bounded by and including the first attitude and the second attitude. The first range of motion and the second range of motion orient the second wing at a first angle relative to the first wing. The windmill rotates the main shaft about the main shaft axis in response to the fluid flow, to generate rotational energy. The rotational energy is captured.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 illustrates a high-level block diagram showing a fluid energy capture system, which can be implemented in accordance with a preferred embodiment;

FIGS. 2A and 2B illustrate an exemplary fluid energy capture wing, which can be implemented in accordance with a preferred embodiment;

FIGS. 3A, 3B, and 3C illustrate an exemplary fluid energy capture wing pair, which can be implemented in accordance with a preferred embodiment;

FIGS. 4A and 4B illustrate an exemplary fluid energy capture system hub, which can be implemented in accordance with a preferred embodiment;

FIG. 5 illustrates an exemplary fluid energy capture system, which can be implemented in accordance with a preferred embodiment;

FIGS. 6A and 6B illustrate an exemplary fluid energy capture wing, which can be implemented in accordance with a preferred embodiment;

FIG. 7 illustrates an exemplary fluid energy capture system configuration, which can be implemented in accordance with a preferred embodiment;

FIG. 8 illustrates exemplary fluid energy capture system configuration data, which can be implemented in accordance with a preferred embodiment;

FIGS. 9A and 9B illustrate an exemplary fluid energy capture wing, which can be implemented in accordance with a preferred embodiment;

FIG. 10 illustrates an exemplary fluid energy capture system, which can be implemented in accordance with a preferred embodiment;

FIGS. 11A and 11B illustrate an exemplary fluid energy capture system hub, which can be implemented in accordance with a preferred embodiment;

FIGS. 12A and 12B illustrate an exemplary fluid energy capture system hub, which can be implemented in accordance with a preferred embodiment;

FIG. 13 illustrates an exemplary fluid energy capture system, which can be implemented in accordance with a preferred embodiment;

FIG. 14 illustrates an exemplary fluid energy capture system, which can be implemented in accordance with a preferred embodiment;

FIG. 15 illustrates an exemplary fluid energy capture system configuration, which can be implemented in accordance with a preferred embodiment; and

FIG. 16 is a flow diagram illustrating an exemplary fluid energy capture method, which can be implemented in accordance with a preferred embodiment.

### DETAILED DESCRIPTION

The particular values and configurations discussed in these non-limiting examples can be varied and are cited merely to illustrate at least one embodiment and are not intended to limit the scope of the invention. While numerous specific details are set forth to provide a thorough understanding of the present invention, those skilled in the art will appreciate that the present invention may be practiced without such specific details. In other instances, well-known elements have been illustrated in schematic or block diagram form in order not to obscure the present invention in unnecessary detail. Additionally, many modifications and variations will be apparent to one of ordinary skill in the relevant arts.

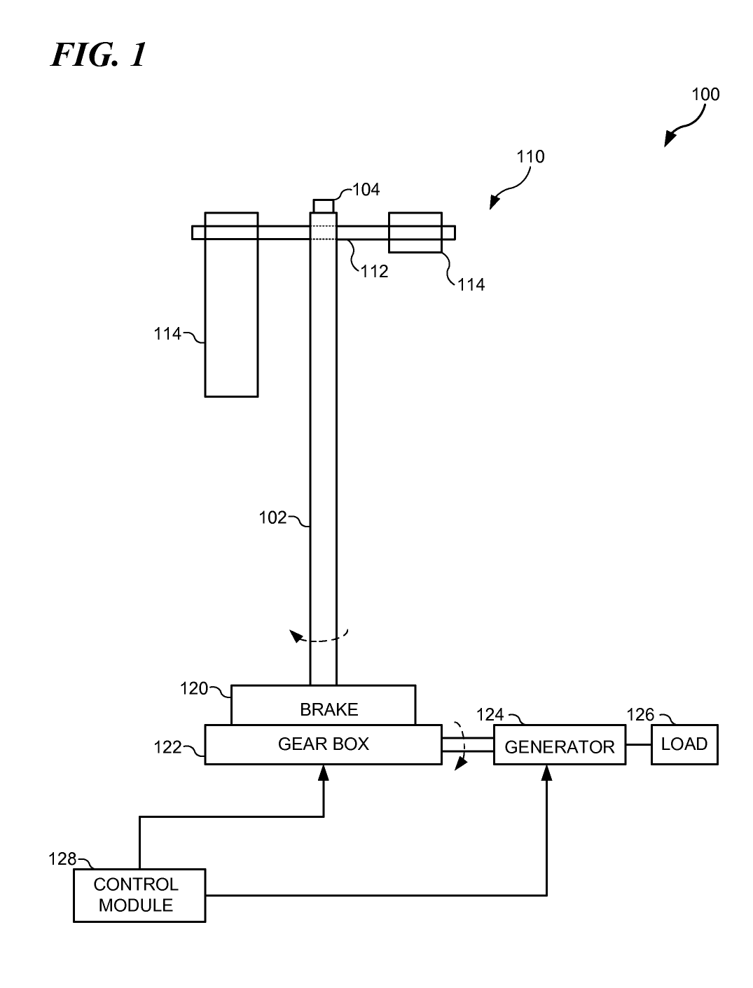

Referring now to the drawings, FIG. 1 illustrates a high-level block diagram of a fluid energy capture system 100. As shown, system 100 includes a main shaft 102 coupled to a fluid energy capture module 110. As described in more detail below, module 110 generally includes one or more axes 112, coupled to one or more pairs of wings 114. Generally, wings 114 interact with fluid flow around module 110 to impart rotational energy to shaft 102, indicated by the directional arrow. Shaft 102 is an otherwise convention shaft, such as a windmill drive shaft, for example.

In the illustrated embodiment, system 100 includes additional standard components configured to control system 100 and to convert rotational energy imparted to shaft 102 into usable electrical energy. For example, shaft 102 couples to a sensor 104. Sensor 104 is an otherwise conventional sensor or sensor array, configured to measure various characteristics of the fluid near module 110, such as, for example, temperature, fluid flow direction, fluid flow velocity, shaft rotation speed, and other suitable environmental and system variables.

As shown, shaft 102 couples to an otherwise conventional gear box 122 and brake 120. Generally, brake 120 applies friction or other mechanism to reduce the rotational speed of shaft 102. Generally, gearbox 122 translates the rotational energy of shaft 102 into rotational energy applied to a generator shaft, such as that coupled to a generator 124, for example. Generator 124 is an otherwise conventional generator configured to receive rotational energy and to convert received rotational energy into electrical energy for delivery to a load 126.

In the illustrated embodiment, system 100 also includes a control module 128. Generally, control module 128 couples to one or more components of system 100, such as, for example, gear box 122 and generator 124 in the illustrated embodiment. In operation, control module 128 monitors various operating indicia, such as operating conditions reported by sensor 104, generator 124 speed, shaft 102 speed, and other suitable indicia. Generally, control module 128 is configured to employ received operating indicia to manipulate control mechanisms on one or more of the system 100 components to achieve operational goals, as described in more detail below.

Generally, system 100 can be configured for operation in a variety of fluid flow environments, such as wind and water, for example. For ease of discussion, the embodiments described herein are mostly described with respect to capturing energy from wind. One skilled in the art will understand that the disclosed embodiments can be converted to suitable water energy capture embodiments with minor modifications. For example, the orientation of wing 114 with respect to the horizontal in a wind configuration is usually configured such that wing 114 does not extend significantly higher than shaft 102. In a water energy capture embodiment, a fully deployed wing 114 can be configured to operate at a depth greater than that of the terminus of shaft 102.

Certain elements of the disclosed embodiments are common to both wind energy and water energy capture systems. A partial list includes drive shaft 102, pairs of wings 114, and a hub coupling one or more wing pairs to shaft 102. Generally, each element works within system 100 to enable and/or assist system 100 to capture fluid energy and convert it to a useful form.

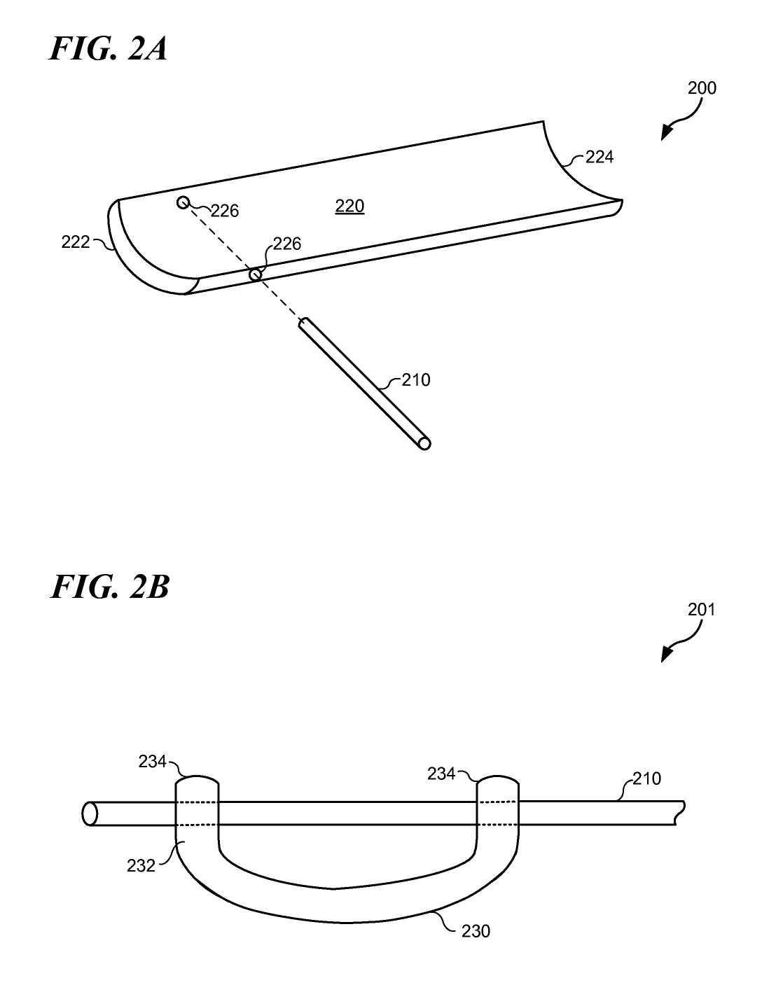

For example, FIG. 2A illustrates an exemplary wing and axle in perspective view. Specifically, system 200 includes wing 220 coupled to an axle 210. In one embodiment, wing 200 is made of any appropriate materials and with any appropriate construction designs that give it sufficient strength for the forces expected to be exerted on it. For example, in one embodiment, wing 200 is made of aluminum, using common aircraft construction methods, which makes the wing relatively light and strong, and therefore proves to be a very satisfactory method of construction.

Generally, wing 200 is configured to be disposed within a fluid flow (here, an airstream) and to present at least two cross-sectional areas to the fluid flow, a maximal cross-section and a minimal cross-section, as described in more detail below. In one embodiment, wing 200 is designed to bend, bow, or otherwise deflect at wind speeds higher than a predetermined maximum, so as to protect the wing from damage caused by high winds.

Generally, in the illustrated embodiment, wing 220 couples to axle 210 through apertures 226. As described in more detail below, wing 220 assumes certain positions relative to the fluid flow, sometimes referred to herein as “attitudes”. Generally, axle 210 couples to wing 220 so as to facilitate transition between operational attitudes. For example, in the illustrated embodiment, wing 220 includes a first face 222 and a second face 224. As shown, apertures 226 are disposed closer to face 222 than to face 224. As described in more detail below, this configuration assists wing 220 to transition between a minimal cross-section (“flying”) attitude and a maximal cross-section (“power”) attitude. For example, in one embodiment of operation, face 222 is the leading edge in the direction of rotation and face 224 is the trailing edge. Thus, in one embodiment, wing 200, as shown mounted on axle 210, can be configured to rotate 90 degrees around the axis of axle 210, dropping the trailing edge, and reorienting wing 200 to a vertical position, as described in more detail below.

FIG. 2B illustrates an end view of an exemplary wing and axle. Specifically, system 201 includes wing 230 coupled to axle 210. As shown, wing 230 includes a body 232 and two winglets 234. The illustrated embodiment, and other illustrations herein, omit various engineering details in order not to obscure the highlighted features. One skilled in the art will understand that generalized or simplified components and elements can be configured to meet contemporary engineering standards and technology without departing from the spirit of the embodiments disclosed herein.

Generally, body 232 is a wing face, which in one embodiment is configured to interact with the wind primarily to produce torque, whether on axle 210 or on the drive shaft to which it is attached. Generally, winglet 234 is a wing face, which in one embodiment is configured to interact with the wind primarily to influence lift forces around wing 230, as described in more detail below. In operation, wing 230 operates as part of a pair of wings, configured in a stable orientation to each other.

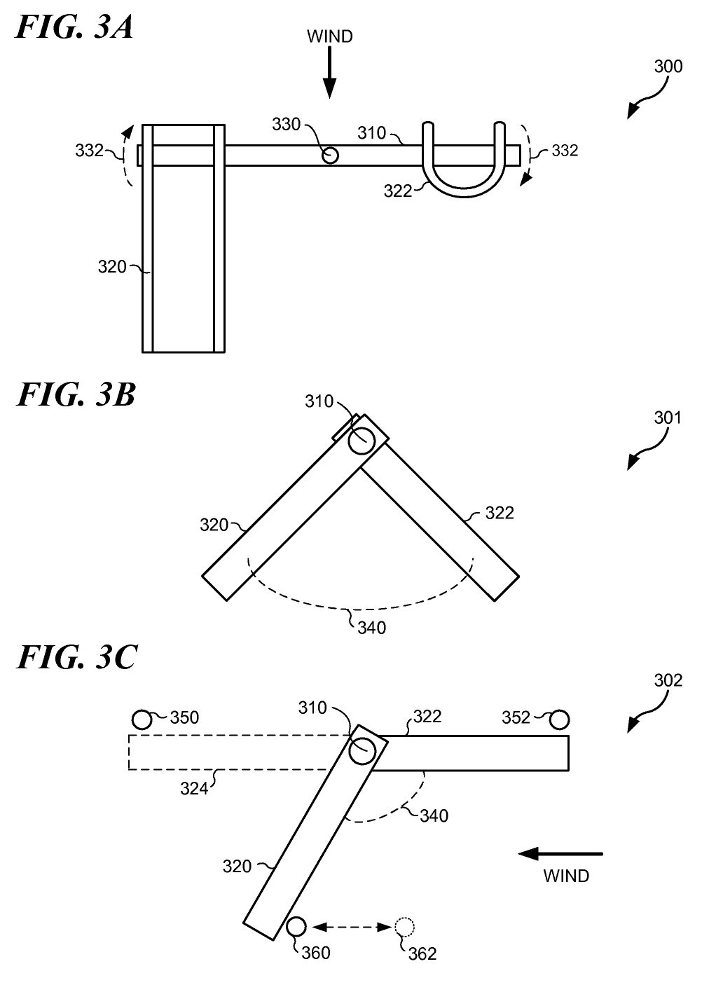

For example, FIG. 3A illustrates an exemplary wing pair 300, in accordance with one embodiment. Specifically, pair 300 includes wing 320 and wing 322, each coupled to axle 310. Axle 310 couples to drive shaft 330, and transforms wind energy applied to wings 320 and 322 into rotational force (i.e., torque) applied to shaft 330. In the illustrated embodiment, with the wind as indicated by the arrow, pair 300 rotates around the axis of shaft 330 as indicated by arrows 332.

Generally, wing 320 couples to axle 310 so that it is vertical when wing 322, also coupled to axle 310, is horizontal. Additionally, in one embodiment, wings 320 and 322 couple to axle 310 so that a low-pressure foiled surface of the leading face of both wings is facing in the same rotational direction.

In the illustrated embodiment, wing 320 and wing 322 are shown in mid-rotation, in different operational attitudes. Specifically, wing 320 is in a “flying” attitude, presenting a reduced cross-section to the wind, which greatly reduces counter-torque (or drag) applied to shaft 330, as described in more detail below. Simultaneously, wing 320 is in a “power” attitude, presenting a maximal cross-section to the wind, the better to capture the energy in the wind, greatly increasing the torque applied to shaft 330. Generally, as used herein, the power attitude presents a larger cross-section to the wind than the flying attitude.

In one embodiment, axle 310 fixes wing 320 and wing 322 in a stable orientation with respect to each other. For example, FIG. 3B illustrates wing pair 301 in an end view of axle 310. As shown wing 320 and wing 322 are oriented at an angle 340 to each other. In one embodiment, angle 340 is ninety degrees. As shown, when fixed at angle 340, when wing 320 is in one attitude, wing 323 is in the counterpart attitude. In operation, as each wing revolves around the drive shaft axis, the wing transitions between the flying attitude to the power attitude and back again, as described in more detail below.

Generally, axle 310 (or, in some embodiments, a hub or other component, as described in more detail below) is configured to restrict the range of motion of wing 320 and wing 322 to the flying attitude at one end of the range of motion, and the power attitude at an opposite end of the range of motion, while maintaining a stable angle between wing 320 and 322. In some cases, however, it is useful to change the magnitude of angle 340. For example, FIG. 3C illustrates system 302, showing a wing pair in an end view of axle 310.

In the illustrated embodiment, wing 320 and wing 322 are oriented at angle 340 to each other. As shown, system 302 includes a plurality of stops, stop 350, 352, and 360. Generally, stops 350, 352, and 360 are otherwise conventional stops and/or stop mechanisms configured to restrict the range of motion of a wing. In the illustrated embodiment, for ease of description, stops 350, 352, and 360 are shown as simple objects fixed in place relative to the wing.

As shown, stop 350 restricts wing 320 from moving beyond a horizontal flying attitude 324. Similarly, stop 352 restricts wing 322 from moving beyond a horizontal flying attitude, as shown. In the illustrated embodiment, both stop 350 and 352 are fixed, but stop 360 is not. Instead, system 302 is configured to move stop 360 from position 362 to increase angle 340. Generally, in position 362, the range of motion of wing 320 includes fully horizontal (“flying”) and fully vertical (“power”).

As shown, moving stop 360 to increase angle 340 restricts wing 320 to a range of motion short of fully vertical. As such, wing 320 presents a smaller cross-section to the wind, which results in reduced force applied to wing 320. In low wind speed operation, a reduced cross-section results in less efficient wind energy capture. In high wind speed operation, however, operating wing 320 in the fully vertical position could expose wing 320 to wind damage. Thus, by restricting wing 320 to a smaller cross-section, system 302 can continue to operate to capture wind energy at higher wind speeds than conventional systems. This dynamic angle management thus improves the ability of the wing pair to capture generate power over a wider range of wind speeds than would otherwise be available to conventional systems.

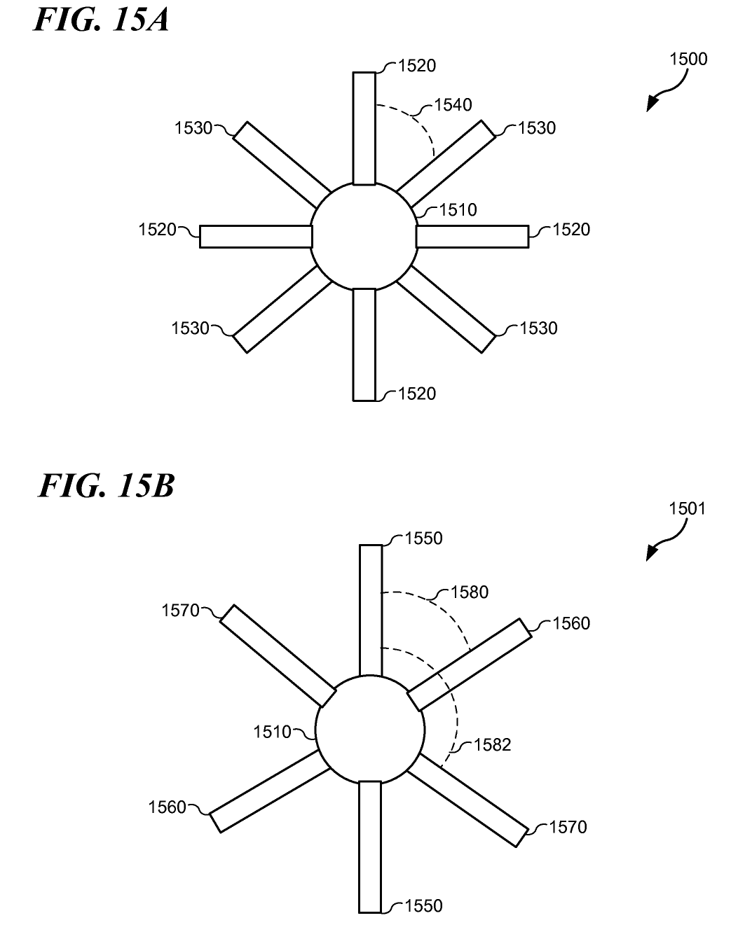

Additionally, in one embodiment, each wing in a wing pair is also configured to yield under high wind conditions by temporarily increasing angle 340 in response to a short gust of wind. So configured, a sudden gust of wind that would otherwise cause catastrophic wing failure instead causes a wing in the power attitude to rotate about its axle's axis so as to increase angle 340. The wing thereby presents a somewhat reduced cross-section to the airstream, which reduces the force on the wing. As the gust subsides, the wing returns to its previous configuration, the prior angle 340. Thus, a system configured with both dynamic and emergency angle management therefore both increases the efficiency of the system across a wide range of wind speeds, while also improving the safety and stability of the system itself. An exemplary wind energy capture operation incorporating these techniques is described in more detail below with respect to FIG. 15.

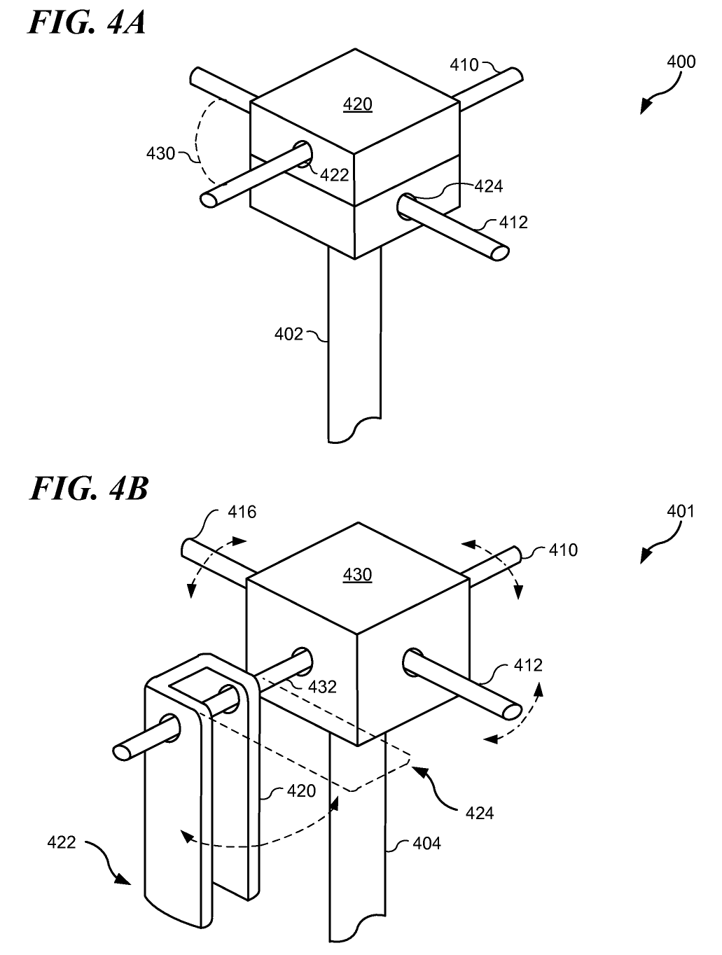

As described above, some embodiments include more than one wing pair. For example, FIG. 4A illustrates an exemplary wind energy capture system 400, in accordance with one such embodiment. In the illustrated embodiment, axles 410 and 412 are shown without their corresponding wings, for clarity.

System 400 includes a hub 420 coupled to a drive shaft 402. Hub 420 also couples to axles 410 and 412. Generally, hub 420 receives torque (and counter-torque) from axles 410 and 412, and transfers the received force to shaft 402. In the illustrated embodiment, hub 420 couples to axle 410 through aperture 422. Generally, aperture 422 is a bearing, port, or other suitable structure. Similarly, hub 420 couples to axle 412 through aperture 424. Generally, hub 420 orients axles 410 and 412 such that neither interferes with the other's operation. In the illustrated embodiment, hub 420 orients axle 410 at an angle 430 from axle 412. In one embodiment, angle 430 is ninety degrees. In embodiments with more than two wing pairs, hub 420 can adjust angle 430 to provide even space between the wing pair axles. In one embodiment, each set of wings is mounted on their respective shafts so as to permit control of the wings to present the desired wing operational attitude to the wind by both dynamic auto-transitioning and dynamic interactive transitioning, as described in more detail below.

In the illustrated embodiment of system 400, axles 410 and 412 are also oriented in different planes of rotation. As shown, axle 410 is “stacked” above axle 412, allowing each axle free range of axial rotation. In alternate embodiments, axles 410 and 412 can be configured in the same plane of rotation around the drive axis. For example, FIG. 4B illustrates an exemplary wind energy capture system 401, in accordance with one such embodiment.

Specifically, system 401 includes hub 430 coupled to drive shaft 404. In some embodiments, each wing of a wing pair couples to a continuous axle. In alternate embodiments, each wing of a wing pair couples to an independent axle, with each axle configured to rotate about its axis. In some embodiments, each independent axle in the wing pair rotates about the same axis, that is, the axles are aligned along the same axis.

As described above, the wings in a wing pair are configured to maintain a stable angle between the wings, as the wings each transition between the operational attitudes. In one embodiment, the axle to which the wing couples maintains and/or modifies as appropriate the angle between the wings. In an alternate embodiment, the hub to which the axles couple manages the angle between the wings of a wing pair.

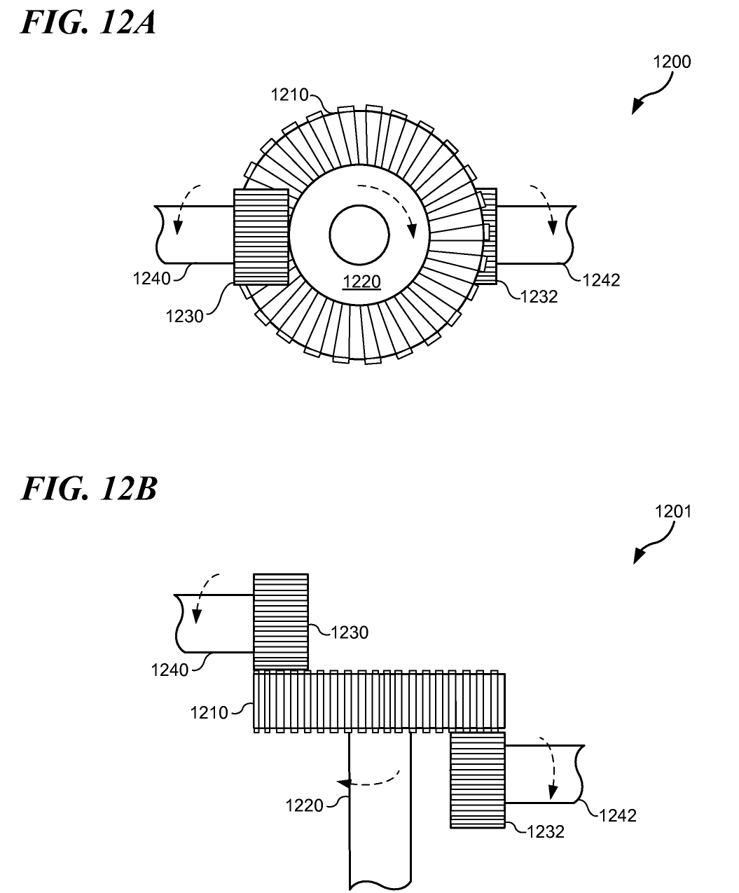

For example, in one embodiment, hub 430 includes a large central horizontal gear (not shown) between each wing, with each wing axle geared to the central gear by a vertical gear on the end of the wing axle. In one embodiment, the central gear is configured with a 90 degree rotational limitation, which allows the gears of the shafts to turn the central gear, and each other, up to the limitation points. As such, hub 430 can be configured to drive one wing of a wing pair on the top side of a central gear, and to drive the other wing in the wing pair on the bottom side of the central gear. FIG. 12, described below, illustrates an exemplary embodiment. So configured, system 401 can support placement of four, six, eight, or more wings in the same vertical plane, while maintaining coordination and interlocking transitions of the wings in a wing pair, and between multiple wing pairs.

For example, in the illustrated embodiment, system 401 includes four independent axles 410, 412, 416, and 432. Hub 430 is configured to restrict the range of motion of each of the independent axles to manage the angle between the wings of each wing pair. For example, hub 430 is configured to restrict the range of motion of axle 432 such that wing 440 is limited to the power attitude 442 on one end and flying attitude 424 on the other end, as described above. Additionally, in one embodiment, hub 430 maintains the angle between wing 440 and the other wing in its wing pair (coupled to axis 410, not shown), such that wing 440 is in the flying position when its partner wing is in the power position, and wing 440 is in the power position when its partner wing is in the flying position, as described above. Additionally, in one embodiment, hub 430 is configured to adjust the angle between wing 440 and the other wing in its wing pair based on wind speed, and to allow a temporary increase in the angle during a sudden increase in wind speed.

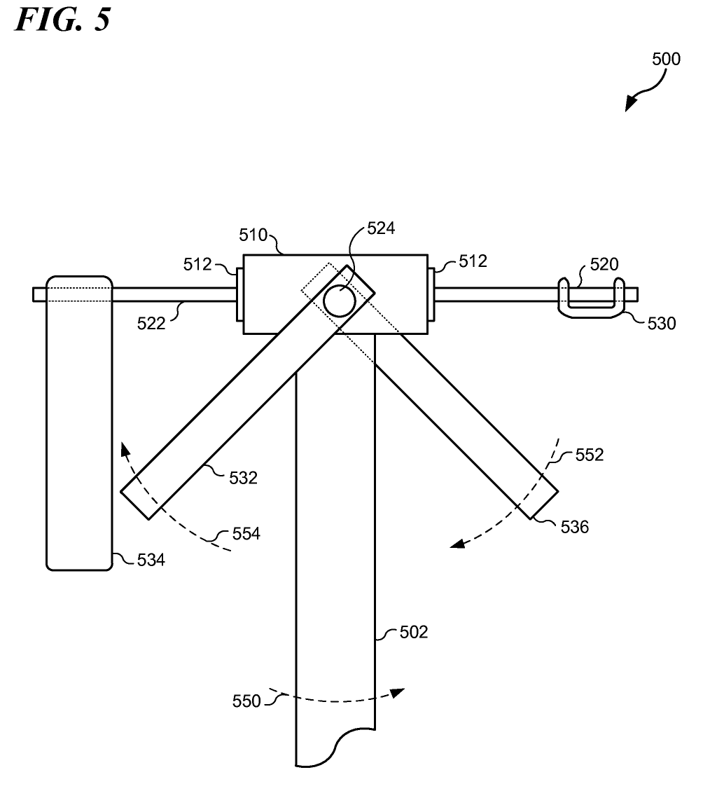

So configured, system 401 provides a wind energy capture system configured for two wing pairs, operating in conjunction, rotating about the axis of drive shaft 404. For example, FIG. 5 illustrates an exemplary embodiment of a wind energy capture system 500 in additional detail.

System 500 includes a hub 510 coupled to a drive shaft 502. In the illustrated embodiment, system 500 includes two wing pairs, coupled to hub 510 in approximately the same plane of rotation. Specifically, system 500 includes a wing pair comprising wing 530, coupled to axle 520 and wing 534, coupled to axle 522. As described above, in one embodiment, axle 520 and axle 522 are the same axle. For example, system 500 also includes a wing pair comprising wing 532 and wing 536, both of which couple to axle 524. Each wing pair axle couples to a bearing 512 of hub 501. Bearing 512 is an otherwise conventional bearing, configured to support an axle while allowing freedom of rotation.

In the illustrated embodiment, system 500 is shown at one point during a rotation in the direction indicated by arrow 550. As described above, in one embodiment, the wing axles are configured to limit the range of motion of the wing, rotating about the axle axis, and to coordinate the transitions between operating attitudes between the two wings of a wing pair. Thus, generally, the wings are mounted in pairs at opposite ends of partially rotatable horizontal axles. As described above, in one embodiment, the axles allow a total movement of about 90 degrees of a single rotation around the axle axis, the extremity of each end of this 90 degrees of rotation being the flying attitude and the power attitude.

Additionally, as described in more detail below, in one embodiment, each wing is configured such that high and low pressure areas arise near the wing, assisting the wing in its transition through most of its rotation about the drive shaft axis. Specifically, in one embodiment, each wing pair is configured such that a high pressure area created near a wing as it moves into the power (vertical) attitude creates lift on the wing, and torque on the wing axle, in the direction of its transition. Moreover, as described above, the wing pairs are coupled such that when one wing moves into the power attitude, the torque on the first wing axle causes torque on the opposite wing's axle, in the direction that moves the opposite wing into the flying (horizontal) attitude.

As described above, the flying attitude is a minimal cross-sectional attitude, which, in one embodiment, presents an upwind cross-sectional surface that is less than 10% of its downwind (power) cross-section. When in the flying attitude, wind pressure against the flying attitude cross-section creates counter-torque on the drive shaft. But because the flying attitude cross-section is significantly smaller than the power attitude, the resultant counter-torque is also significantly smaller than the torque applied in the direction of rotation of the drive shaft. As such, the flying attitude greatly reduces the cross-sectional counter-torque of the upwind wings, which reduces the counter-torque offsetting a large percentage of the torque created by the downwind wings. Accordingly, the embodiments disclosed herein enjoy a much greater efficiency of wind pressure converted to output-torque at the drive shaft.

That is, in one embodiment, the shape and pairing of the wings and their rotation limitation is such that high pressure on the downwind wing causes the upwind wing to move into the flying attitude. Further, the initial pressure of the wind on the upwind surface of the upwind wing, and the freedom of the axle to rotate in the direction of the pressure, creates force to move the downwind wing into the power attitude as it is coming into to a downwind relationship to the wind. Thus, the action of the wind on each opposing wing, operating through the partial rotation of the common axle, enhances the operational transitions of the wings.

First, the wind action on a wing tends to position that wing in the desired cross-sectional attitude with respect to the wind direction. Second, the wind action on one wing also tends to position the opposite wing in the wing pair in that wing's desired cross-sectional attitude. The wind action thus encourages a coordinated movement of each opposing wing in harmony with the other. Additionally, the wing pairing and rotational limitation also transfers some torque on the wing to the power shaft (via the hub in one embodiment).

For example, in one embodiment, the wings are shaped on one side to create a maximum high-pressure area near the wing's downwind, rotational-trailing surface and are shaped on the opposite side to create a low-pressure area on the wing's leading edge as it transitions between operational attitudes. As described in more detail below, as a wing is coming out of the downwind rotation (power attitude) a high-pressure area forms near the wing's surface. During the transition from the power attitude to the (upwind) flying attitude, the rotation of the wing around the drive shaft axis carries the wing through a crosswind phase preliminary to the flying attitude.

During this transitional rotation across the wind, the shape of the front of the wing creates a low-pressure area near the front of the wing surface that increases the wind velocity on the leading edge. This low-pressure area creates lift on the wing, which is translated by the hub into torque in the desired direction of rotation of the drive shaft. Similarly, as the wing transitions from the flying attitude to the power attitude, a low-pressure area forms near the wing, also creating lift and torque in the direction of rotation of the drive shaft.

This lift-generated torque varies as the wing transitions between operational attitudes. The lift-generated torque created during a transition from the power attitude to the flying attitude is strongest at the beginning of the transition and weakest at the end of the transition. Similarly, the lift-generated torque created during a transition from the flying attitude to the power attitude is weakest at the beginning of the transition and strongest at the end of the transition. However, as each wing is part of a wing pair configured to transition in cooperation, their inverse pressure/lift relationship is such that the lift-generated torque created by one wing also dampens the lift-generated torque created by that wing's companion in the wing pair.

In one embodiment, these dynamic off-setting pressures also cause the two opposite wings to transfer torque to the windmill frame as they transition. As described above, a wing in transition from the power attitude to the flying attitude applies a varying amount of torque to the drive shaft, from a high torque to zero torque or a small counter-torque. This varying torque delivers the wing into the flying attitude as the opposite wing transitions from the flying attitude to the power attitude. As described above, a wing in transition from the flying attitude to the power attitude applies a varying amount of torque to the drive shaft, from a small counter-torque to a maximal torque as the wing enters the power attitude. These lift-generated torques help improve the efficiency of the system to capture the fluid energy.

This efficiency is one important result of the cooperative interaction of the wings in a wing pair. In one embodiment, this cooperative interaction persists throughout the entire range of rotation of the wing pair about the drive shaft axis. For example, in the illustrated embodiment, wings 532 and 536, a wing pair, are in complementary transitional phases. Specifically, wing 536 is in transition from the horizontal flight (minimal cross-sectional) attitude to the vertical power (maximum cross-sectional) attitude, rotating about the axis of axle 524 in the direction indicated by arrow 552. During this transition, wing 536 contributes torque in a range from a small counter-torque to maximum torque in the direction of the main shaft rotation (indicated by arrow 550).

Similarly, wing 532 is transition to the horizontal flight (minimal cross-sectional) attitude from the vertical power (maximum cross-sectional) attitude, rotating about the axis of axle 524 in the direction indicated by arrow 554. During this transition, wing 536 contributes torque in a range from maximum torque to a small counter-torque in the direction of the main shaft rotation. Thus, as described in more detail below, in one embodiment, the torque contribution of wing 532 is a constant dynamic inverse to the torque contribution characteristics of wing 536.

Moreover, in the phase of rotation about the drive shaft depicted in FIG. 5, together wing 532 and wing 536 contribute positive torque. That is, as the operational attitude of wing 532 to the wind is the complement of the operational attitude of wing 536, the low pressure lift areas created on each wing's leading surface operate in the same direction with respect to the individual wing. But as the wings are on opposite sides of hub 510, the low pressure lift areas of the wings together cause one wing to exert a dampening effect to counter somewhat the lift of the other wing. The result is that wings 532 and 536 dampen each other's torque contributions as they transition between operational attitudes. In some phases of the rotation around the drive shaft axis, the dampened force translated to the hub is proportional to the offset of the forces between wing 532 and 536.

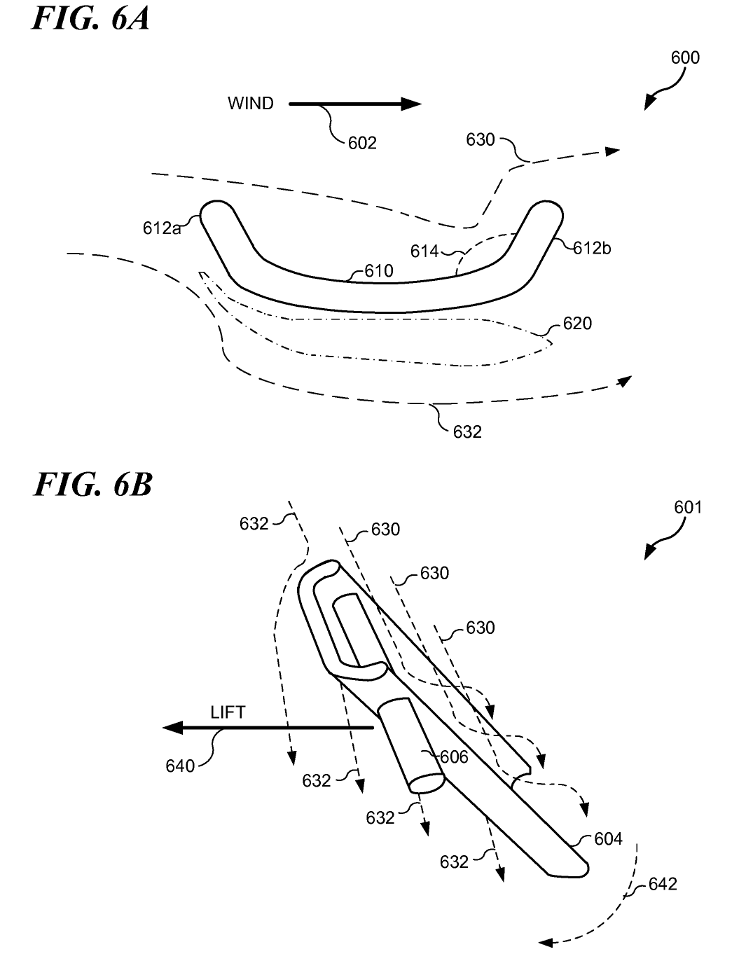

FIGS. 6A and 6B describe in more detail certain aspects of wing features and fluid dynamics around the wings. Generally, the wing features are configured to improve wing performance during the transitions between operational attitudes. As described above, these wing features can be configured to improve the torque characteristics of the wings, in part by causing a low-pressure area to be created near the leading surface of the wing and high-pressure area to be created near the trailing surface. Specifically, FIG. 6A illustrates a wing 600 disposed in an airstream moving in the direction indicated by arrow 602.

Wing 600 is an otherwise conventional wing, modified as described herein. Specifically, wing 600 includes a body 610 and two winglets 612a and 612b. In the illustrated embodiment, each winglet 612 couples to body 610 at an angle 614. In one embodiment, angle 614 is 45 degrees. In one embodiment, angle 614 can be configured to optimize the performance of wing 600, based on the wing material, expected airspeed in operation, and other suitable factor. In the illustrated embodiment, winglet 612a is configured as an identical counterpart to winglet 612b, configured to provide similar flight performance independent of whether the airflow orientation is such that winglet 612a is the leading or trailing edge with respect to the airflow. In an alternate embodiment, winglet 612a and 612b can be configured with different flight characteristics.

Wing 600 is disposed in an airstream created by wind moving in the direction indicated by arrow 602. In the illustrated embodiment, the wind and its interaction with wing 600 are symbolized by lines 630 and 632. Further, lines 630 and 632 are generalizations of airflow across wing 600 and are abstracted from actual experimental data, but do not represent specific data. As such, lines 630 and 632 illustrate general principles in order not to obscure the highlighted features.

As shown, line 632 illustrates the interaction of winglet 612a with the wind, creating a low-pressure area 620 near wing 600, particularly near body 610. As shown, line 630 illustrates the interaction of winglet 612b with airflow downstream from winglet 612a, deflecting the airflow and creating a high-pressure area near wing 600, on the opposite side of the wing from the low-pressure area 620.

FIG. 6B illustrates a similar wing 601 disposed in a similar airstream, from a different perspective. As described above, lines 630 indicate airflow across one face of wing 601, creating a high-pressure area on the concave face of the wing. Similarly, lines 632 indicate airflow across the opposite face of wing 601, creating a low-pressure area near the convex face of the wing. The combination of a high-pressure and low-pressure area near wing 601 causes two lift forces. First, the airflow creates lift in the direction of the wing's rotation around the drive shaft, as indicated by arrow 640. This lift acts to apply torque, “drive shaft torque,” to the drive shaft in the desired direction of rotation. As described in more detail below, wing 600 can be configured to generate drive shaft torque during approximately 270 degrees of a 360 degree procession around the drive shaft.

Second, the airflow around wing 601 creates torque on the wing itself. More particularly, wing 601 includes a wing body 604 fixed to a wing axle 606. The airflow around wing 601 creates some torque in the direction indicated by arrow 642, which applies force to the wing body 604, in the direction indicated, to rotate wing body 604 about the axis of axle 606. Thus, this torque, “wing axle torque” or “axial torque,” operates to support wing 601 in the transition from the flying attitude to the power attitude. One skilled in the art will understand that when the airflow is in the reverse direction, such as when the wing is in the opposite crosswind transition, the wing axle torque operates to assist wing 601 in the transition from the power attitude to the flying attitude.

That is, the effect of the wind on a wing, and therefore the contribution of that wing to the total torque applied to the drive shaft, is partly a function of the wing's position with respect to the wind and the drive shaft. For example, in one embodiment, the range of motion around the drive shaft of each wing traces a circle, which is divided into four 90 degree sections. In one embodiment, in three of these 90 degree sections, the wing converts wind into torque in the desired direction of drive shaft rotation, and in one of the 90 degree sections, the wing's wind interaction causes a relatively very small, almost negligible, counter-torque on the drive shaft.

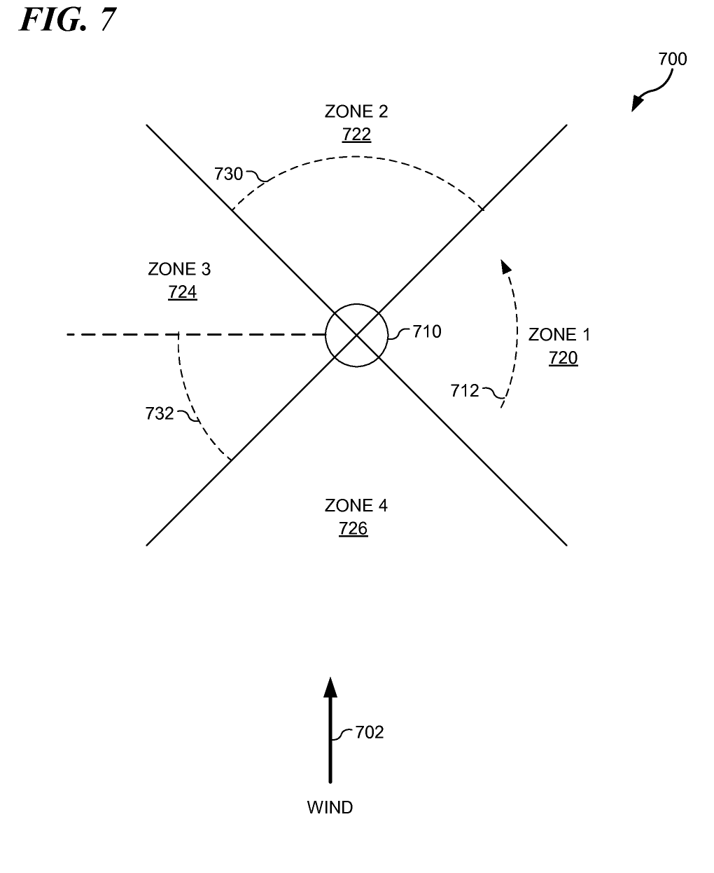

For example, FIG. 7 illustrates a high-level block diagram showing a wind energy capture system 700 partitioned into four operational zones. System 700 includes an energy capture system 710 as described herein, such as system 500 of FIG. 5, for example. In the illustrated embodiment, system 700 is disposed in an airstream generally flowing as indicated by arrow 702, and system 710 rotates as indicated by arrow 712.

Generally, system 700 is partitioned into four segments (also known as “quadrants” and/or “zones”). Generally, in the first segment, Zone 1 720, the wing is transitioning from a mostly vertical attitude, through the power attitude, into a mostly vertical attitude before a transition to the flying attitude. In one embodiment, in Zone 1, the wing is moving entirely with the wind. In one embodiment, Zone 1 is the “downwind zone.”

Generally, in the next segment, Zone 2 722, the wing is in transition from a mostly vertical attitude to a mostly horizontal attitude, as the wing passes through a crosswind behind the drive shaft. In one embodiment, in Zone 2, the wing is moving across the direction of the wind. In one embodiment, Zone 2 is the “high-to-low torque transitional zone.”

Generally, in the next segment, Zone 3 724, the wing is transitioning from a mostly horizontal attitude, through the flying attitude, into a mostly horizontal attitude before a transition to the power attitude. In one embodiment, in Zone 3, the wing is moving entirely against the wind. In one embodiment, Zone 3 is the “upwind zone.”

Generally, in the next segment, Zone 4 726, the wing is in transition from a mostly horizontal attitude to a mostly vertical attitude, as the wing passes through a crosswind in front of the drive shaft. In one embodiment, in Zone 4, the wing is moving across the direction of the wind. In one embodiment, Zone 2 is the “low-to-high torque transitional zone.”

Generally, each Zone covers a segment of the wing's path represented by angle 730. In one embodiment, angle 730 is 90 degrees and each Zone is substantially the same size. In one embodiment, the precise borders of each Zone depend on changing environmental factors, including wind speed and direction, small differences between the wings and across the wing itself, among other factors. In the illustrated embodiment, the zones are oriented with the wind such that the center of Zone 4 is directly facing the wind. In an alternate embodiment, the zones are oriented as an offset angle 732 from the perpendicular to the wind direction.

In one embodiment, each Zone is configured expressly and system 710 includes control mechanisms to orient each wing according to its Zone location as the wing travels around the drive shaft axis. In an alternate embodiment, each Zone arises as a function of the procession of the wings around the drive shaft axis and, as such, each Zone is a descriptive construct and not a mechanical or operational restraint.

In one embodiment, each wing creates its maximum drive shaft torque in Zone 1, as the wing travels downwind and presents its maximum cross section to the wind. Similarly, each wing creates a lesser, but still significant drive shaft torque in Zone 2, as the wing transitions between Zone 1 and Zone 3 and from maximum positive torque to zero torque. In Zone 3, in some embodiments, each wing creates no positive torque, but significantly reduces counter-torque by transitioning into the flying attitude as it moves upwind. In Zone 4, the wing creates torque roughly equivalent to that created in Zone 2 as it transitions from Zone 3 back to Zone 1. In Zone 4, the wing is transitioning from zero positive torque to maximum positive torque.

Thus, each Zone covers a portion of the path a wing travels as the wing moves through space around the axis of the drive shaft. So configured, the location of a wing with respect to that path can be represented as a phase angle measuring the distance the wing has moved along the path from a predetermined starting location. Further, as described above, the operational attitude of the wing changes as the wing moves through each segment. As such, the phase angle of the wing can be configured to indicate the wing's transition and attitude.

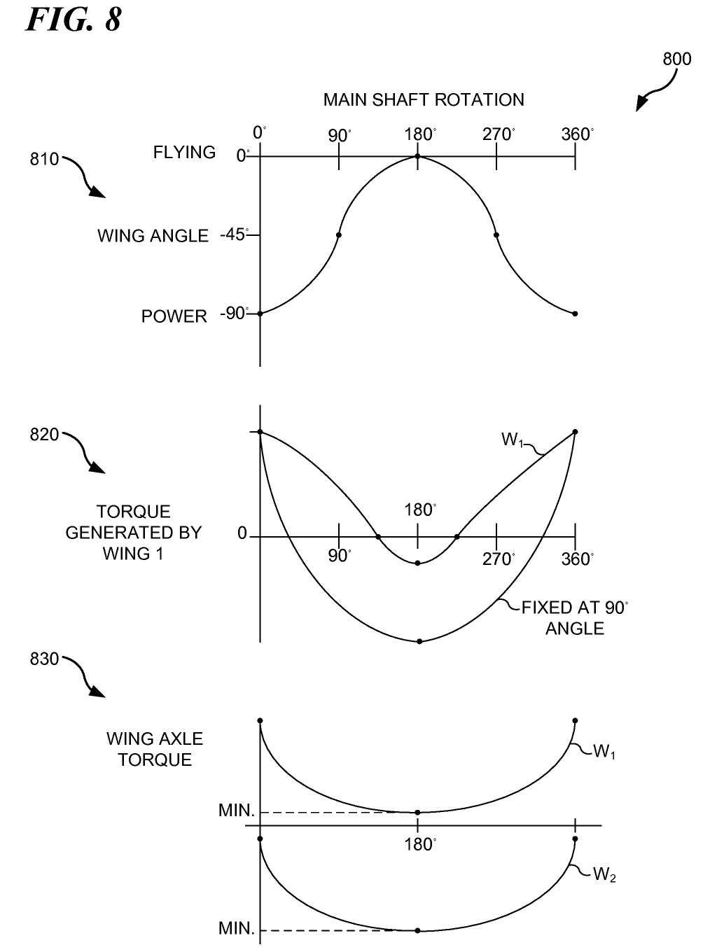

For example, FIG. 8 illustrates a collection of charts 800 illustrating generalized data relating to a wing as it travels around the drive shaft axis. The data represented by the illustrated curves have been abstracted to illustrate the principles underlying the embodiments disclosed herein and are not based on specific measured data.

In particular, chart 810 illustrates the wing attitude of a wing as it travels around the main shaft axis, in terms of the angle of deflection from the horizontal. For ease of illustration, the starting orientation (0 degrees) represents the point of the wing's orbit around the drive shaft axis at which the wing is completely in the power attitude, which is a 90 degree deflection from the horizontal (i.e., the wing is completely vertical). In the illustrated embodiment, this deflection is represented as a negative deflection, and the power attitude is shown at negative 90 degrees. Thus, as shown, at the point 180 degrees into the wing's orbit, the wing is completely in the full flying attitude, with 0 degrees deflection (i.e., horizontal). As shown, the wing transitions from the power attitude to flying attitude, and back again, once per revolution around the drive shaft axis.

Chart 820 illustrates a representation of the drive shaft torque generated by a wing, W1, as it travels around the drive shaft axis. Wing W1 is configured to transition between the power attitude and flying attitude as described with respect to chart 820. As shown, wing W1 generates maximum drive shaft torque in the power attitude, and a small counter-torque in the flying attitude and close transitional attitudes. Further, wing W1 generates positive torque throughout most of the wing's transit around the drive shaft axis. Also shown is a curve representing the torque characteristics of a hypothetical wing fixed in the power attitude, as is customary for typical common systems. As shown, the fixed attitude wing generates significantly more counter-torque, which peaks when the fixed wing is travelling directly upwind. Thus, as shown, the wind capture systems disclosed herein offer significant improvements over common systems.

Chart 830 illustrates wing axle torque generated by a wing as it moves in its orbit around the drive shaft axis. In the illustrated embodiment, wings W1 and W2 form a wing pair. Generally, wing W1 generates wing axle torque in one rotational direction about the axle axis, and wing W2 generates wing axle torque in the opposite direction about the axle axis. In the illustrated embodiment, therefore, wing axle torque generated by wing W1 is a positive number, and that generated by wing W2 is a negative number.

As shown, both wing W1 and W2 generate the maximum positive (or minimal negative) axial torque when wing W1 is in the power attitude (and wing W2 is in the flying attitude), and the minimal positive (or maximal negative) axial torque when wing W1 is in the flying attitude (and wing W2 is in the power attitude). Thus, the net torque fluctuates to a maximum positive axial torque (moving wing W1 into the power attitude) and a maximum negative axial torque (moving wing W2 into the power attitude). Accordingly, the net torque generated by wings W1 and W2 as the wings travel around the drive shaft axis fluctuates, generally toward moving one wing or the other into the power attitude as that wing travels across the wind from the flying attitude.

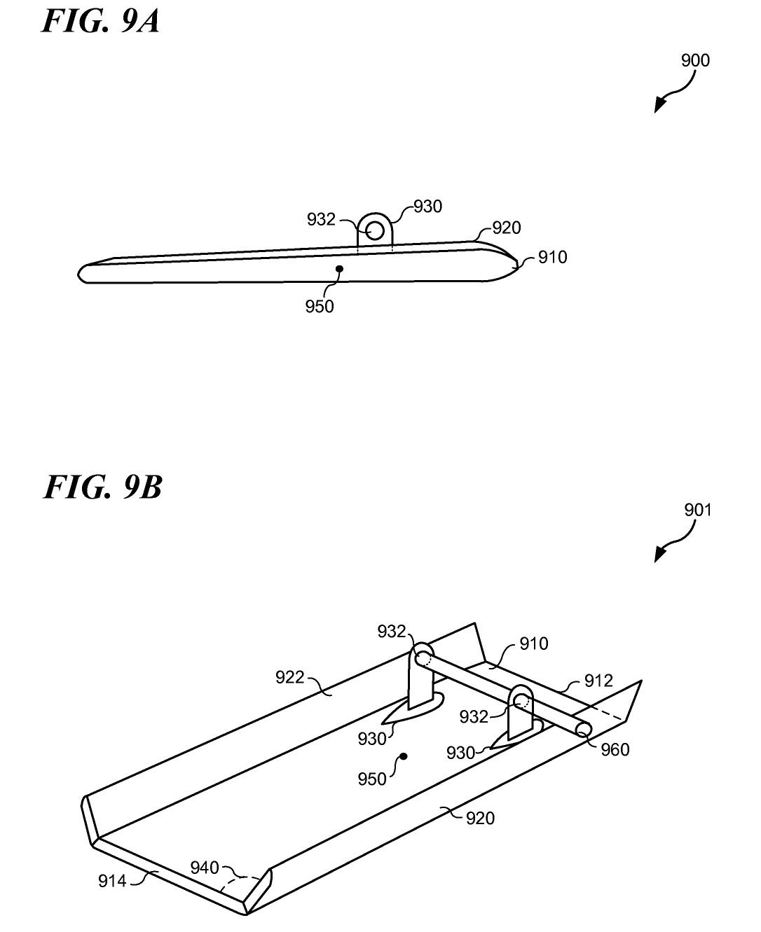

As described above, in one embodiment, each wing is configured as a wing body coupled to an axle at an aperture closer to one end of the wing than the other. In an alternate embodiment, other suitable wing configurations can also be employed. For example, FIGS. 9A and 9B illustrate an exemplary alternative embodiment.

Specifically, FIG. 9A illustrates a side view of a wing 900. Generally, wing 900 includes a body 910, a pair of winglets 920, and an attachment 930. In one embodiment, body 910 is a generally foil-shaped wing. In the illustrated embodiment, a first winglet 920 couples to body 910 along one side of body 910, parallel to the direction of airflow. Wing 900 also includes a second winglet 910 (not shown) coupled to body 910 along the opposite side of body 910 as the first winglet 920. Generally, a winglet 920 is a wing feature configured to influence airflow moving across wing 910 perpendicular to winglet 920. Attachment 930 couples to body 910 and is configured to couple wing 900 to a wing axle (not shown). In one embodiment, attachment 930 couples to a wing axle via aperture 932. In one embodiment, aperture 932 is configured to fix wing 900 to the wing axle without allowing free rotation of wing 900 about the axle. In the illustrated embodiment, attachment 930 is disposed at a position on a face of body 910 that is just forward of the center of gravity (CG) 950 of body 910, as described in more detail below.

FIG. 9B illustrates a perspective view of a wing 601. In the illustrated embodiment, wing 601 includes a body 910. Body 910 includes a leading edge 912 and a trailing edge 914. Generally, leading edge 912 is configured as a foil leading edge and is the leading edge when wing 601 is in the flying attitude. Similarly, trailing edge 914 is configured as a foil trailing edge and is the trailing edge when wing 601 is in the flying attitude.

A first winglet 920 couples to body 910 along one edge, generally perpendicular to the leading and trailing edges. A second winglet 922 couples to body 910 along the edge opposite winglet 920. In the illustrated embodiment, winglets 920 and 922 are shown as discrete components independent of body 910. In an alternate embodiment, winglets 920 and/or 922 are configured as features of body 910. In the illustrated embodiment, winglets 920 and 922 couple to body 910 at an angle 940. In one embodiment, angle 940 is 135 degrees. In an alternate embodiment, angle 940 is configured to optimize lift created by airflow across body 910. In one embodiment, angle 940 is configured to reduce vortex drag near trailing edge 914.

An pair of attachments 930 couple to body 910. In the illustrated embodiment, each attachment 930 includes an aperture 932. Generally, aperture 932 is configured to receive a wing axle 960 and to fix wing 901 to wing axle 960 at a predetermined orientation. In the illustrated embodiment, each attachment 930 is disposed at a position on a face of body 910 that is a small distance toward edge 912 from the center of gravity 950 and a small distance away from a winglet 920 (or 922). As such, each attachment 930 is a small amount closer to edge 912 than edge 914 and is disposed next to a winglet 920 or 922. In an alternate embodiment, attachment 930 is disposed at a center of gravity of body 910. In an alternate embodiment, attachment 930 is disposed at a position corresponding to a center of rotation of body 910.

So configured, forces generating axial torque on body 910 generally result in smaller axial torque than that experiences by wings configured with the attachment point closer to one edge. That is, where attachment 930 is closer to a center, equidistant point, the effective lever arm of an axial torque force is shorter, reducing the axial torque applied to the wing. As such, wing 910 experiences reduced axial torque, which reduces wear, which improves wing longevity. Moreover, the reduced axial torque applied to the wing also reduces wear on the mechanism employed to limit the range of motion of the wings, that is, in one embodiment, the stops that limit each wing to the power attitudes and flying attitudes. Reduced wear on the stops also improves performance and longevity.

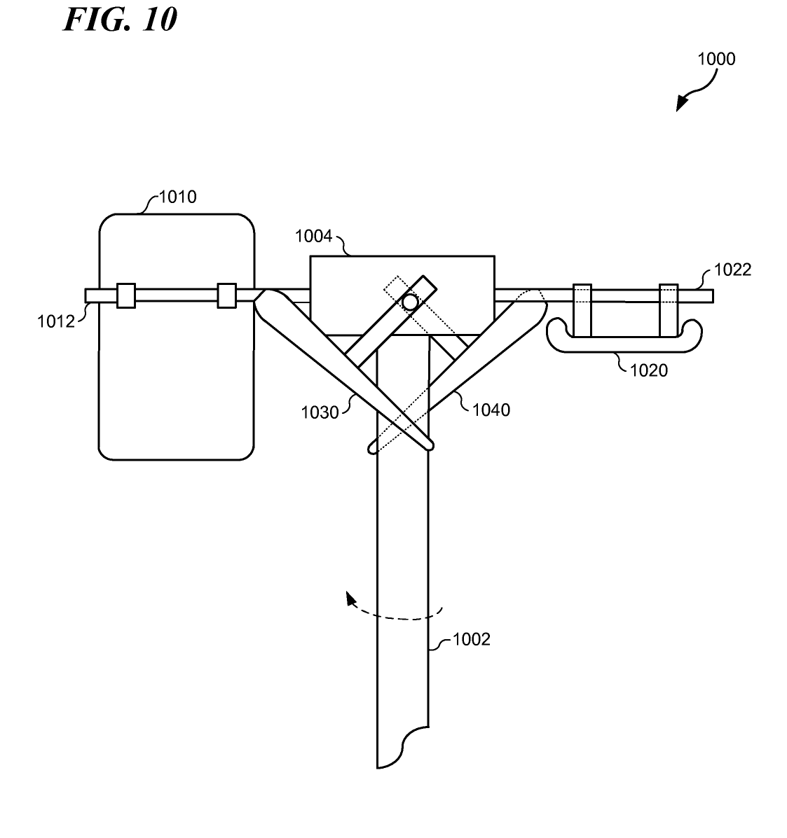

FIG. 10 illustrates an exemplary fluid capture system configured with wings as described in FIGS. 9A and 9B. In the illustrated embodiment, system 100 includes a drive shaft 1002, configured to rotate in the direction indicated by the arrow, and coupled to a hub 1004. In the illustrated embodiment, hub 1004 couples to a plurality of wings, generally configured to receive wind force and apply torque to hub 1004 in response to received wind force.

Specifically, system 1000 includes wing 1010, coupled to wing axle 1012. Wing 1010 is paired with a wing 1020, which couples to wing axle 1022. Generally, wing axle 1012 and 1022 are configured to maintain a stable relative configuration between wing 1010 and 1020. Specifically, when, as shown, wing 1010 is in a maximal cross-sectional attitude (analogous to the power attitude described above), wing 1020 is in a minimal cross-sectional attitude (analogous to the flying attitude described above).

As the wings rotate around the axis of drive shaft 1002, the wings transition from the power attitude to the flying attitude and back again, in a manner similar to that described in more detail above. For example, wing 1030 is shown in transition from the flying attitude to the power attitude, while its counterpart in the wing pair, wing 1040, is in transition from the power attitude to the flying attitude. So configured, the wing pairs present fluctuating cross-sectional areas to the wind, generating drive shaft torque and minimizing upwind drag, as described above.

In the illustrated embodiment, the placement of the attachment points coupling a wing to its wing shaft also contribute to the stability and operation of system 1000. For example, as shown, wing 1010 couples to shaft 1012 at attachment points just forward of the center of gravity of wing 1010. So configured, airflow that would otherwise create torque to move wing 1010 out of the power attitude instead tends to stabilize wing 1010 in the power attitude, which tends to improve wind energy capture efficiency. Further, as wing 1010 moves out of the power zone, and wing 1020 moves into the power zone, these same forces move wing 1020 into the power position. As wings 1010 and 1020 are part of the same wing pair, operating in cooperation, movement of wing 1020 in to the power position also moves wing 1010 into the flying position.

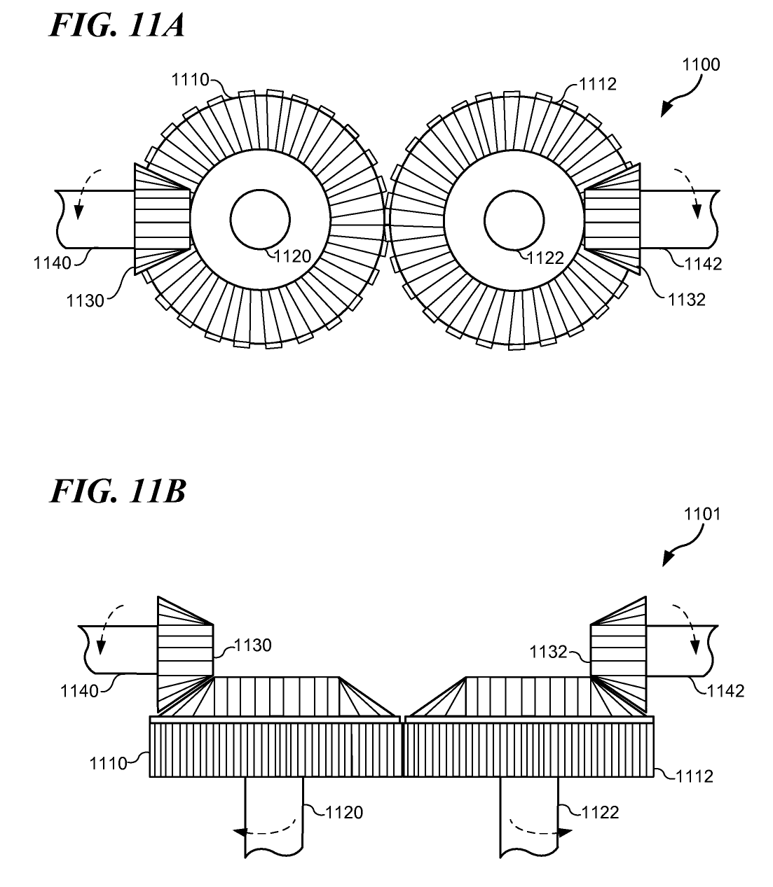

As described above, in one embodiment, this cooperation can be implemented as an aspect of the axles to which the wings attached and/or as an aspect of the hub to which the axles attach. For example, FIGS. 11A and 11B illustrate two perspectives of an exemplary hub system that can be configured to coordinate the transitions of two wings in a wing pair.

Specifically, FIG. 11A illustrates a top view of a system 1100 and FIG. 11 B illustrates a side view of system 1100. Generally, system 1100 is configured to coordinate rotation of the wings in a wing pair. Specifically, in the illustrated embodiment, system 1100 includes horizontal gears 1110 and 1112. Generally, horizontal gears 1110 and 1112 are otherwise conventional gears, configured to interact with each other as connected gears.

Horizontal gear 1110 rotates about an axle 1120 and couples to a vertical gear 1130. Generally, vertical gear 1130 is an otherwise conventional gear, configured to interact with gear 1110 conventionally. Vertical gear 1130 couples to a wing axle 1140. Generally, axle 1140 is an otherwise conventional wing axle, configured to rotate with gear 1130.

Similarly, horizontal gear 1112 rotates about an axle 1122 and couples to a vertical gear 1132. Generally, vertical gear 1132 is an otherwise conventional gear, configured to interact with gear 1112 conventionally. Vertical gear 1132 couples to a wing axle 1142. Generally, axle 1142 is an otherwise conventional wing axle, configured to rotate with gear 1132.

In an illustrated operation, rotation of wing axle 1140 causes rotation of vertical gear 1130, which, as coupled to gear 1110, causes gear 1110 to rotate about axle 1120. Gear 1110 causes gear 1112 to rotate about axle 1122, turning gear 1132, which rotates wing axle 1142. Thus, system 1100 causes axles 1140 and 1142 to rotate in cooperation. Where the wings are fixed at a predetermined relative angle, system 1100 limits the rotation of the axles, and therefore the wings, while maintaining the relative angle.

As described above, in one embodiment, this cooperation can be implemented through a central horizontal gear, to which the wing axles attach. For example, FIGS. 12A and 12B illustrate two perspectives of an exemplary hub system that can be configured to coordinate the transitions of two wings in a wing pair. For clarity, the illustrated embodiment shows only a single wing pair. Alternate embodiments can be configured for additional wing pairs.

Specifically, FIG. 12A illustrates a top view of a system 1200 and FIG. 12B illustrates a side view of system 1200. Generally, system 1200 is configured to coordinate rotation of the wings in a wing pair. Specifically, in the illustrated embodiment, system 1200 includes horizontal gear 1210. Generally, horizontal gear 1210 is an otherwise conventional gear, configured to interact with other gears as is conventional.

Horizontal gear 1210 rotates about an axle 1220 and couples to a first vertical gear 1230 on one side of gear 1210. Generally, vertical gear 1230 is an otherwise conventional gear, configured to interact with gear 1210 conventionally. Vertical gear 1230 couples to a wing axle 1240. Generally, axle 1240 is an otherwise conventional wing axle, configured to rotate with gear 1230. Similarly, horizontal gear 1110 couples to a second vertical gear 1232, on the opposite side of gear 1210 as gear 1230. Generally, vertical gear 1232 is an otherwise conventional gear, configured to interact with gear 1210 conventionally. Vertical gear 1232 couples to a wing axle 1242. Generally, axle 1242 is an otherwise conventional wing axle, configured to rotate with gear 1232.

In an illustrated operation, rotation of wing axle 1240 causes rotation of vertical gear 1230, which, as coupled to gear 1210, causes gear 1210 to rotate about axle 1220. Gear 1210 turns gear 1232, which rotates wing axle 1242. Thus, system 1200 causes axles 1240 and 1242 to rotate in cooperation. Where the wings are fixed at a predetermined relative angle, system 1200 limits the rotation of the axles, and therefore the wings, while maintaining the relative angle.

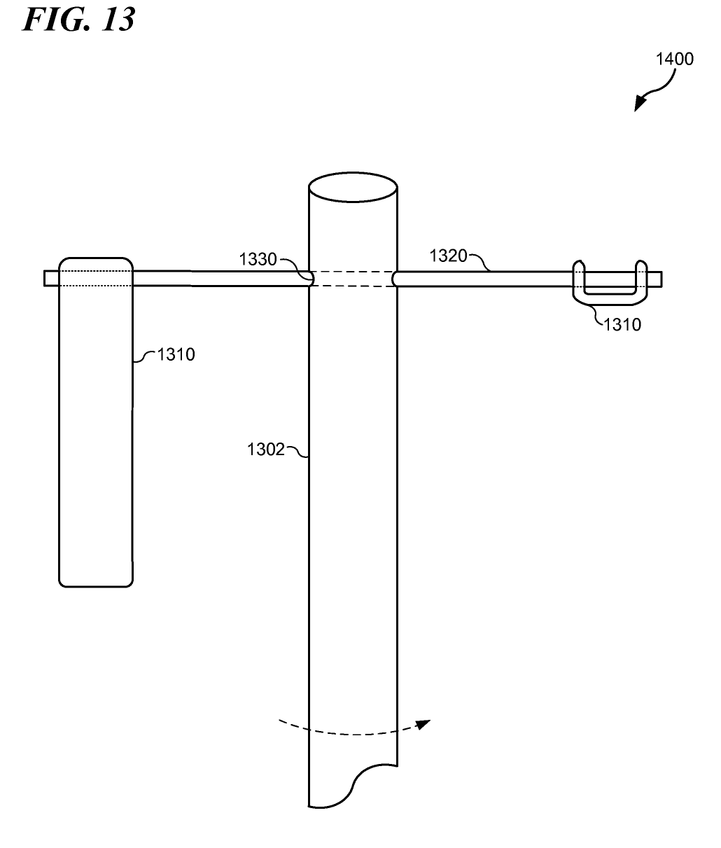

In a simplified embodiment, the interaction of the wind itself can serve to coordinate the transitions of the wings between attitudes. For example, FIG. 13 illustrates a system 1300, which can be configured in accordance with one embodiment. System 1300 includes a drive shaft 1302, configured to rotate in the direction indicated by the arrow.

System 1300 includes a wing pair 1310 coupled to a wing axle 1320 in a fixed configuration and relative angle. As shown, when one wing 1310 is in the power attitude, the counterpart wing is in the flying attitude. In the illustrated embodiment, system 1300 is configured with a simplified hub 1330. In the illustrated embodiment, hub 1330 is configured as an aperture through drive shaft 1302, such that axle 1320 is free to rotate about its axis within hub 1330. So configured, the lift forces operating on the wings, as described above, apply axial torque to move each wing into the power attitude as that wing transitions from the upwind zone into the downwind zone. As the wings are fixed in position relative to each other, the axial torque moving one wing into the power attitude overcomes the axial counter-torque of the other wing, moving the other wing into the flying attitude as it enters the upwind zone from the downwind zone.

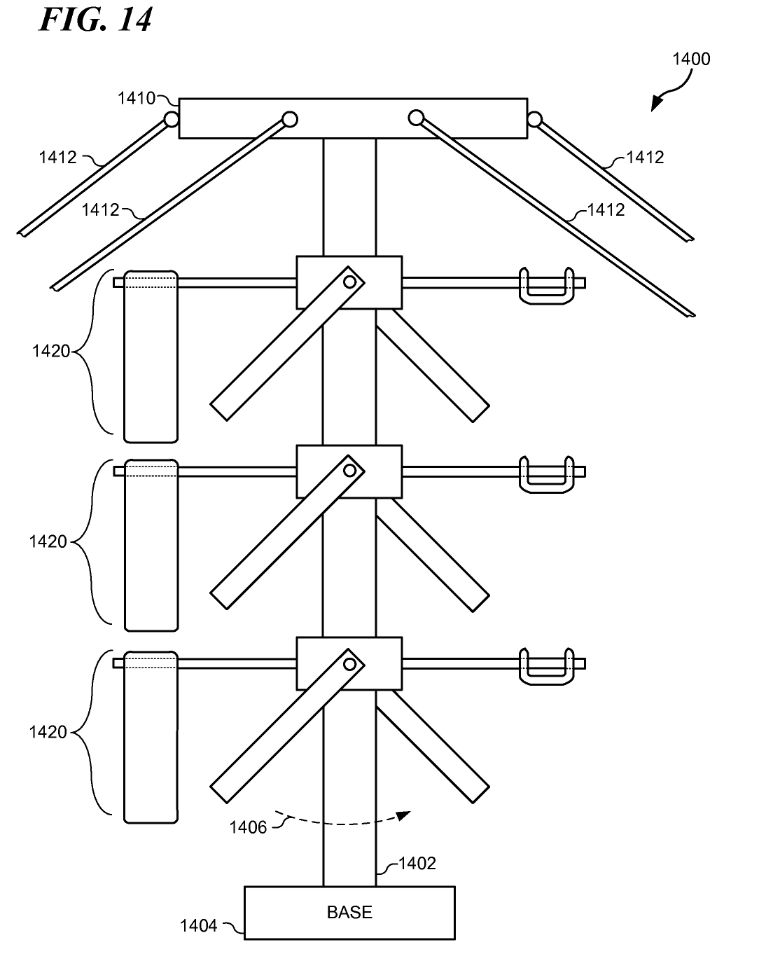

In the illustrated embodiment, FIG. 13 illustrates a single wing pair. In an alternative embodiment, a plurality of wing pairs can be configured in a single plane of rotation, coupled to a drive shaft with a plurality of planes of rotation. For example, FIG. 14 illustrates an exemplary wind energy capture system in accordance with one embodiment.

Specifically, FIG. 14 illustrates a system 1400. System 1400 includes a drive shaft 1402, coupled to a base 1404, and configured to rotate in the direction of arrow 1406. Drive shaft 1402 also couples to a support module 1410. Generally, module 1410 is configured to couple to and support shaft 1402, while allowing shaft 1402 free rotation along its axis. In the illustrated embodiment, a plurality of guy wires 1412 couple to and secure module 1410 to a fixed location relative to shaft 1402.

In the illustrated embodiment, system 1400 includes three windmills 1420. As shown, each windmill 1420 includes two wing pairs arranged with axles approximately in the same plane of rotation. As illustrated, the windmills 1420 are stacked vertically along shaft 1402, and are spaced so as to prevent interference between the wings of neighboring windmills and other components of system 1400. In the illustrated embodiment, the wing pairs of each windmill 1420 are aligned vertically with the wing pairs of a neighboring windmill. In an alternate embodiment, neighboring windmill wing pairs are offset vertically.

For example, FIG. 15A illustrates a top view of an exemplary system 1500, which can be configured in accordance with one embodiment. Specifically, system 1500 includes a shaft 1510. A first windmill 1520, with two wing pairs (wings omitted for clarity), couples to shaft 1510 at one plane of rotation. A second windmill 1530, also with two wing pairs, couples to shaft 1510 at another plane of rotation. In the illustrated embodiment, the wing pairs of windmill 1520 are offset from the wing pairs of windmill 1530 by an offset angle 1540. In one embodiment, angle 1540 is configured to provide a similar angle between each wing pair of windmill 1520 and windmill 1530.

So configured, miscellaneous lateral forces generated by windmill 1520, which would otherwise cause vibrations in system 1500, are somewhat offset by comparable miscellaneous lateral forces generated by windmill 1530. Additionally, variations in wind capture and the resultant energy output caused by variations in the airstream over the wings of windmill 1520 are also somewhat offset by comparable variations affecting windmill 1530. Thus, the offset windmills together produce a smoother torque output than would the same windmills configured vertically aligned.

In the illustrated embodiment, system 1500 includes two windmills, each with two wing pairs. In an alternate embodiment, each windmill can be configured with one wing pair, three wing pairs, or other suitable numbers of wing pairs. In embodiments with greater than two wing pairs rotating in the same plane around the drive shaft, each wing is configured to transition between operational attitudes without interfering with the transitions of neighboring wings. Moreover, windmills with other than two wing pairs can also be stacked along a drive shaft.

For example, FIG. 15B illustrates a top view of an exemplary system 1501, which can be configured in accordance with one embodiment. Specifically, system 1501 includes a shaft 1510. A first windmill 1550, with one wing pair (wings omitted for clarity), couples to shaft 1510 at one plane of rotation. A second windmill 1560, with one wing pair, couples to shaft 1510 at a second plane of rotation. A third windmill, also with one wing pair, couples to shaft 1510 at a third plane of rotation.

In the illustrated embodiment, windmill 1560 couples to drive shaft 1510 such that its wing pair is offset vertically from the wing pair of windmill 1550 by an angle 1580. Similarly, windmill 1570 couples to drive shaft 1510 such that its wing pair is offset vertically from the wing pair of windmill 1550 by an angle 1582. In one embodiment, angle 1580 and angle 1582 are configured such that the angle between any wing and its nearest neighbor is approximately equal. In an alternate embodiment, angle 1582 is configured to offset the wing pair of windmill 1570, such that the angle between the wing pairs of windmill 1570 and windmill 1560 is the same as angle 1580.

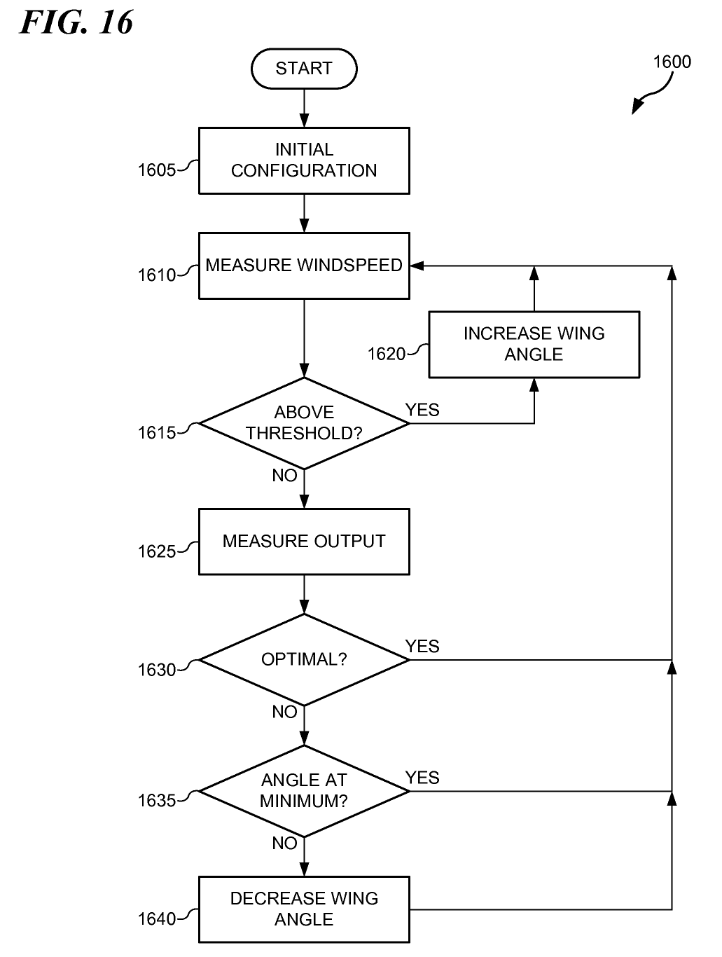

The embodiments disclosed herein can thus be configured to capture fluid energy from a fluid flow, and convert that captured energy into rotational energy of a drive shaft. Additionally, as described above, the disclosed embodiments can be configured to operate efficiently in a wider range of environmental conditions than common systems. For example, FIG. 16 depicts a flow diagram 1600 illustrating an exemplary method, which can be configured in accordance with one embodiment.

The process begins at block 1605, wherein a wind capture system, such as system 100 of FIG. 1, for example, is in an initial configuration. In one embodiment, the initial configuration is a resting state. In an alternate embodiment, the initial configuration can be configured as an operational state arising after a warm-up period of operation.

Next, as indicated at block 1610, the system measures the wind speed near the rotating wing pair. For example, in one embodiment, sensor 104 of FIG. 1 measures the wind speed near hub 112. Next, as indicated at decisional block 1615, the system, such as control module 128 of FIG. 1, for example, determines whether the wind speed is above a predetermined threshold. In one embodiment, the predetermined threshold is the lowest wind speed above which the wing pair would likely suffer damage from continued operation as currently configured. In one embodiment, the predetermined threshold is a fixed threshold. In an alternate embodiment, the predetermined threshold is a function of the wind speed and the angle between the wings in the wing pair.

If at decisional block 1615 the system determines that the wind speed is above the predetermined threshold, the process continues along the YES branch to block 1620. As indicated at block 1620, the system increases the wing angle between the wings of a wing pair, as described above. In one embodiment, the system increases the wing angle so that both wings are substantially in the flying attitude throughout their entire orbit around the drive shaft axis. In an alternate embodiment, the system increases the wing angle by a predetermined amount. In one embodiment, the predetermined amount is 5 degrees. The process returns to block 1610.

If at decisional block 1615 the system determines that the wind speed is not above the predetermined threshold, the process continues along the NO branch to block 1625. As indicated at block 1625, the system measures the system output. In one embodiment, the system output is a measure of the revolutions per minute (rmp) of the drive shaft. In an alternate embodiment, the system output is a measure of the rpm of a generator shaft coupled to the gear box. In an alternate embodiment, the system output is a measure of the electrical power delivered by a generator coupled to the drive shaft. One skilled in the art will understand that there are various measurements that can be employed to measure the system output.

Next, as indicated at decisional block 1630, the system determines whether the system output is optimal. In one embodiment, the system output is optimal when the ratio of the wind speed to the drive shaft rpm falls within a predetermined range. In one embodiment, the system output is optimal when the generator shaft rpm falls within a predetermined range. Generally, whether the system output is optimal is a function of the specific operational objectives of the system, which is determined by the system users. As such, in one embodiment, the system output is optimal when the system output meets predetermined criteria.

If at decisional block 1630 the system output is optimal, the process continues along the YES branch, returning to block 1610. If at decisional block 1630 the system output is not optimal, the process continues along the NO branch to decisional block 1635. As indicated at decisional block 1635, the system determines whether the wing angle between the wings is at a predetermined minimum. In one embodiment, the minimum wing angle is 90 degrees.

If at decisional block 1635 the wing angle is at the minimum, the process continues along the YES branch, returning to block 1610. In one embodiment, when the wing angle is at the minimum, the cooperation between wings presents the maximal cross-section of one wing in the power attitude, as the other wing is in the flying attitude. If at decisional block 1635 the wing angle is not at the minimum, the process continues along the NO branch to block 1640.

As indicated at block 1640, the system decreases the wing angle between the wings of the wing pair. In one embodiment, the system decreases the wing angle to the minimum. In an alternate embodiment, the system decreases the wing angle by a predetermined amount. In one embodiment, the predetermined amount is 5 degrees. Thus, in one embodiment, when the system output is non-optimal, and the wing angle is such that the wings do not transition into a full vertical power attitude, presenting their maximal cross-sectional area, the system can decrease the wing angle, which (until the minimal angle) increases the cross-sectional area as the downwind wing achieves a more vertical attitude.

The process returns to block 1610, wherein the system measures the wind speed. As such, the embodiments disclosed herein can be configured to respond dynamically to changing operational environmental conditions, while maintaining broad safety and efficiency targets. Moreover, in both stable and varying environmental conditions, the embodiments disclosed herein can be configured to provide fluid energy capture systems and methods superior to common systems and methods.

More particularly, the embodiments disclosed herein include a dynamic balance of wing positions on partially rotatable axles to interactively present the proper cross-section of the wings to the wind at all times, respective of the wings position to the wind in regard to the objective of creating maximum conversion of wind pressure to torque on the vertical windmill shaft. Thus, as generally described above, the embodiments disclosed herein provide numerous technical advantages over prior art systems and methods.

For example, in typical systems, wing cross-sections shaped to create low pressure in front of the wing as it moves into the wind can only create this low pressure as an offset to its cross-sectional resistance to the wind as it rotates upwind. Thus, this cross-sectional resistance creates a counter-torque on the wing, and thus the shaft, which the upwind side design of the wing converts to a low-pressure area in front of the wing that only partially offsets the cross-sectional counter-torque of the wing. The net torque of the wing traveling upwind is, though reduced, still a significant counter-torque on the windmill.

But embodiments disclosed herein greatly offset this counter-torque. This net counter-torque of the wings rotating upwind must be off-set by the wings traveling downwind before any torque in the desired direction can be realized. Certain of the disclosed embodiments achieve positive torque by maximizing the high-pressure design of the downwind sides of the wings in order to create the maximum pressure and torque. Such embodiments not only offset the counter-torque of the wings rotating upwind, but also provide a surplus of torque in the desired direction of rotation.

Moreover, the embodiments disclosed herein also provide a dynamic wing design that reduces the cross-section of the wings rotating upwind to a fraction, in some cases less than 10%, of the cross-section of the wings traveling downwind. Additionally, each wing functions as part of a pair, cooperating in transition from a power attitude to a flying attitude and back again. Thus, this dynamic adjustment in cross-section is a function of each opposing wing's interaction with the wind and each other. In one embodiment, this cooperative adjustment is achieved, in part, through a partially rotatable axle on which the opposing wings are mounted at either end.

This coordinated, dynamic transitioning of the wing cross-sections gives increased efficiency to the energy capture system. In some embodiments, the improved efficiencies approaches the efficiencies of propeller-driven horizontal windmills, without also suffering from some of the disadvantages of earlier approaches. Furthermore, the embodiments disclosed herein are is effective in small (10,000 watts to 50,000 watts), large (100,000 watts to 250,000 watts) and mega (500,000 watts to 1.5 Mega watts) sized designs, offering improved efficiency across a broad range of power-supply requirements.

As such, generation dynamos can be developed to match optimized rotational speeds of the disclosed embodiments, and the large torques they are capable of creating, which further improves the system, resulting in a much more cost effective and cost maintainable fluid energy capture system, operating in a broad spectrum of generating ranges. Furthermore, the disclosed embodiments can be constructed using known methods, which keeps the startup cost of the systems to approximately the same equipment costs as with earlier systems. For example, with the use of common aircraft style wing construction, modified as described herein, very large embodiments can be created that can create megawatts of power.

Additionally, the disclosed embodiments are substantially omni-directional. As described above, the operation of the wings, and the dynamic transition between operational attitudes is, in part, a function of the wind direction. Accordingly, as the wind shifts, the wings naturally respond according to the Zone in which the wings are presently operating. Thus, the wings provide nearly continuous torque generation, even if the current Zone (after the wind shift) is now very different than the Zone in which the wing was before the wind shifted. As the wings rotate around the drive shaft axis, the Zones automatically reorient, as the wings continue to generate torque throughout most of their orbit. As such, the embodiments disclosed herein are continuously aligned with the wind, without requiring complicated control structures to re-orient the windmills and/or supporting structures when the wind shifts.

One skilled in the art will appreciate the embodiments disclosed above, and other features and functions, or alternatives thereof, may be desirably combined into many other different systems or applications. Additionally, various presently unforeseen or unanticipated alternatives, modifications, variations or improvements therein may be subsequently made by those skilled in the art, which are also intended to be encompassed by the following claims.

What is claimed is:

1. A system, comprising:
a main shaft configured to rotate about a main shaft axis, the main shaft comprising a hub;
a first axle coupled to the hub and configured to rotate about a first axle axis in a first range of motion;
a first wing coupled to the first axle;
wherein the first range of motion is configured to orient the first wing within a range of attitudes bounded by and including a first attitude and a second attitude;
wherein the first attitude is configured to present a first cross sectional surface area relative to a predetermined fluid flow direction;
wherein the second attitude is configured to present a second cross sectional surface area relative to the predetermined fluid flow direction;
wherein the first cross sectional surface area is larger than the second cross sectional surface area;
a second axle coupled to the hub and configured to rotate about a second axle axis in a second range of motion;
wherein the second axle axis is parallel to first axle axis;
a second wing coupled to the second axle;
wherein the second range of motion is configured to orient the second wing within a range of attitudes bounded by and including the first attitude and the second attitude; and
wherein the first range of motion and the second range of motion are configured to orient the second wing at a first angle relative to the first wing.

2. The system of claim 1, wherein hub further comprises a first stop configured to restrict the range of motion of the first axle.

3. The system of claim 2, wherein the first wing further comprises:
a body, a first winglet, and a second winglet;
wherein the first winglet is disposed at about a 45 degree angle with respect to the body; and
wherein the second winglet is disposed at about a 45 degree angle with respect to the body.

4. The system of claim 1, wherein the hub comprises a plurality of gears configured to restrict the range of motion of the first axle and the second axle.

5. The system of claim 1, wherein the first angle is ninety degrees.

6. The system of claim 1, wherein the first angle is configured to orient the second wing in the second attitude when the first wing is oriented in the first attitude, and to orient the second wing in the first attitude when the first wing is oriented in the second attitude.

7. The system of claim 1, wherein the hub is further configured to modify the first angle.

8. The system of claim 1, further comprising a control module configured to change the first angle based on a measured fluid flow rate.

9. The system of claim 1, wherein the first wing comprises a foil shape.

10. The system of claim 9, wherein the foil shape is configured:
to generate axial torque in a first direction when the first wing is in a first orientation with respect to the predetermined fluid flow direction; and
to generate axial torque in a second direction, the second direction counter-rotational to the first direction, when the first wing in is a second orientation with respect to the wing.

11. The system of claim 1, further comprising:
wherein the first wing, the first axle, the second wing, and the second axle comprise a first wing pair;
a second wing pair, the second wing pair coupled to the hub at a first phase angle from the first pair.

12. The System of claim 11, further comprising a third wing pair, the third wing pair coupled to the hub at a second phase angle from the first pair.

13. The system of claim 1, wherein the second axle axis and first axle axis are the same axis.

14. A method for capturing fluid energy, comprising:
disposing a windmill within a fluid flow, the fluid flow comprising a flow direction;
wherein the windmill comprises:
a main shaft configured to rotate about a main shaft axis, the main shaft comprising a hub;
a first axle coupled to the hub and configured to rotate about a first axle axis in a first range of motion;
a first wing coupled to the first axle;
wherein the first range of motion is configured to orient the first wing within a range of attitudes bounded by and including a first attitude and a second attitude;
wherein the first attitude is configured to present a first cross sectional surface area relative to the flow direction;
wherein the second attitude is configured to present a second cross sectional surface area relative to the flow direction;
wherein the first cross sectional surface area is larger than the second cross sectional surface area;
a second axle coupled to the hub and configured to rotate about a second axle axis in a second range of motion;
wherein the second axle axis is parallel to first axle axis;
a second wing coupled to the second axle;
wherein the second range of motion is configured to orient the second wing within a range of attitudes bounded by and including the first attitude and the second attitude; and
wherein the first range of motion and the second range of motion are configured to orient the second wing at a first angle relative to the first wing;
wherein the windmill is further configured to rotate the main shaft about the main shaft axis in response to the fluid flow, to generate rotational energy; and
capturing the rotational energy.

15. The method of claim 14, further comprising:
measuring the fluid flow; and
modifying the first angle based on the measured fluid flow.

16. The method of claim 15, wherein modifying the first angle based on the measured fluid flow comprises increasing the first angle as fluid flow increases beyond a predetermined threshold value.

17. The method of claim 15, wherein modifying the first angle based on the measured fluid flow comprises varying the first angle with the fluid flow so as to optimize the capture of rotational energy.

18. A system for generating electrical energy, comprising:
a main shaft configured to rotate about a main shaft axis in response to applied torque, generating rotational energy, the main shaft comprising a first hub, a second hub, and a third hub;
a first turbine module coupled to the first hub and configured to apply torque to the main shaft, comprising:
a first axle coupled to the first hub and configured to rotate about a first axle axis in a first range of motion;
a first wing coupled to the first axle;
wherein the first range of motion is configured to orient the first wing within a range of attitudes bounded by and including a first attitude and a second attitude;
wherein the first attitude is configured to present a first cross sectional surface area relative to the flow direction;
wherein the second attitude is configured to present a second cross sectional surface area relative to the flow direction;
wherein the first cross sectional surface area is larger than the second cross sectional surface area;
a second axle coupled to the hub and configured to rotate about a second axle axis in a second range of motion;
wherein the second axle axis is parallel to first axle axis;
a second wing coupled to the second axle;
wherein the second range of motion is configured to orient the second wing within a range of attitudes bounded by and including the first attitude and the second attitude; and
wherein the first range of motion and the second range of motion are configured to orient the second wing at a first angle relative to the first wing;
a second turbine module coupled to the second hub, the second turbine module configured to apply torque to the main shaft;
a third turbine module coupled to the third hub, the third turbine module configured to apply torque to the main shaft;
a gearbox coupled to the main shaft;
a generator shaft coupled to the gearbox;
wherein the gearbox is configured to translate rotational energy of the main shaft into rotational energy of the generator shaft; and
a generator coupled to the generator shaft, the generator configured to convert rotational energy of the generator shaft into electrical energy.

19. The system of claim 18, wherein the first hub is configured to modify the first angle based on a determined fluid flow.

20. The system of claim 18, further comprising:
wherein the second turbine module is offset from the first turbine module at a first phase angle, and
wherein the third turbine module is offset from the first turbine module at a second phase angle.
